(19) United States
(12) Patent Application Publication
(10) Pub. No.: US 2003/0195882 A1
(43) Pub. Date: Oct. 16, 2003

(54) Homepage searching method using similarity recalculation based on URL substring relationship

(76) Inventors: Chung Hee Lee, Daejeon (KR); Myung-Gil Jang, Daejeon (KR); Sang Kyu Park, Daejeon (KR); Dong-Yul Ra, Seongnam-si (KR); Eui-Kyu Park, Seoul (KR); Jung-Sik Jang, Daegu (KR)

Correspondence Address: JACOBSON HOLMAN PLLC, 400 SEVENTH STREET N.W., SUITE 600, WASHINGTON, DC, 20004, US

(21) Appl. No.: 10/252,439

(22) Filed: Sep. 24, 2002

(30) Foreign Application Priority Data
Apr. 11, 2002 (KR) 2002-19647

(51) Int. Cl. G06F 17/30; G06F 7/00

(52) U.S. Cl. 707/5

(57) ABSTRACT

A homepage searching method uses a similarity recalculation based on a URL substring relationship. An entry point of a homepage is searched among a plurality of web documents belonging to the homepage by using their substring relationships. The technical essence lies in that the present invention uses a principle that if a URL of a certain web document is a substring of a URL of another web document, the former is more likely to be an entry point of a homepage than the latter. Thus, the present invention improves a conventional information searching method and allows a page serving as an entry point of a homepage to be searched prior to other documents. Accordingly, a user can determine whether a searched web document is a homepage or not without visiting all the URLs of the searched web documents.

### FIELD OF THE INVENTION

The present invention relates to a homepage searching method; and, more particularly, to a homepage searching method using a similarity recalculation based on a URL substring relationship.

### FIELD OF THE INVENTION

As the amount of information scattered in a web environment has been increased, there has been intensified a demand for an effective searching system for use therein. However, most of conventional web document searching systems simply serve to search for web documents including words contained in a searching query raised by a user and, then, provide the searched web documents as a searching result.

Since most of the current web searching systems just arrange the searched web documents, the searching result for the searching query includes both homepages and other web documents. Accordingly, the user has to visit URLs of the searching result one by one in order to find whether a certain URL is a homepage or just a web document.

In recent years, however, there has been enhanced a tendency in which the users want to search for a homepage, i.e. a web site, rather than just a web document, because the homepage contains a variety of information concerned with the query that they raised. Such recent trend has in turn increased a demand for a web searching system capable of primarily searching for a homepage containing information related to the searching query, which could not be satisfied by the conventional web searching systems. This type of searching is referred to as a “homepage searching”, and the homepage searching has become more and more important in recent web searching performances. Since a homepage is created focused on a specific subject with a specific purpose, a word corresponding to the subject or the purpose may appear in many different web documents within the homepage. Accordingly, if a web site, i.e., a homepage, of the web documents in which a word contained in the searching query inputted from the user appears is searched and provided as the searching result, the user may obtain more various information from the searched homepage.

As mentioned above, however, the conventional web searching systems perform the web searching process and provide the searching result without distinguishing the homepage from the web documents. Thus, the user who intends to visit the homepage should check one by one all the URLs of the searching result to find the desired homepage.

For example, if a searching query “Yonsei University” is inputted, the searching result may include not only a homepage of the Yonsei University but also, e.g., a web document of a person who graduated from the Yonsei university, a web document supported by the Yonsei university, various web documents existing in the Yonsei University, etc. However, if what the user really wants is the homepage, i.e., an entry point of the Yonsei University, the user cannot find the desired information easily because so many other web documents containing the word “Yonsei University” are also provided.

As such, in order to overcome the above-cited disadvantages of the conventional web searching systems, many researches have been directed to develop a homepage searching technology capable of primarily searching for a homepage by using a depth of a URL of a web document. The method using the URL depth of the web document uses a structure of a URL and is operated based on the principle that if a URL of a searched web document has the form of a homepage URL, the web document is determined as a homepage. However, this method using the URL depth also shows a limit in terms of its exactness because it uses just the URL form of the web document.

### SUMMARY OF THE INVENTION

It is, therefore, an object of the present invention to provide a method for searching a homepage by using a similarity recalculation based on a URL substring relationship.

In accordance with the present invention, there is provided a homepage searching method using a similarity recalculation based on a URL substring relationship, the method comprising the steps of: (a) extracting a general text from web documents searched in response to a web searching request provided from a user; (b) indexing the extracted general text to generate an index file for use in performing a web searching process; (c) outputting a searching result defining rankings of the web documents by considering weights of the web documents and a searching query; (d) recalculating similarities of the web documents on the ranking list by using URL substring relationships between the web documents; and (e) readjusting the rankings of the web documents based on the recalculated similarities and, then, displaying the searching result in a manner that the web document corresponding to the homepage has a priority.

### BRIEF DESCRIPTION OF THE DRAWINGS

The above and other objects and features of the present invention will become apparent from the following description of preferred embodiments given in conjunction with the accompanying drawings, in which:

FIG. 1 provides a block diagram of a homepage searching system based on a URL substring relationship in accordance with a preferred embodiment of the present invention;

FIG. 2 describes the concept of a web searching using a URL substring relationship in accordance with the preferred embodiment of the present invention;

FIG. 3 sets forth a flowchart illustrating an operation of a web document processing unit within the web searching system shown in FIG. 1;

FIG. 4 depicts a flowchart of an operation of a web document indexing unit within the web searching system shown in FIG. 1;

FIG. 5 illustrates an example of an index file structure generated by the web document indexing unit in FIG. 4;

FIG. 6 offers a flowchart of an operation of a web document searching unit within the web searching system shown in FIG. 1;

FIG. 7 exhibits a flowchart of an operation of a similarity recalculating unit within the web searching system shown in FIG. 1;

FIG. 8 explains the concept of a similarity recalculation based on a URL substring relationship in accordance with the preferred embodiment of the present invention;

FIG. 9 demonstrates an exemplary diagram of a source code for the similarity recalculating program using the URL substring relationship shown in FIG. 8; and

FIG. 10 presents a flowchart of an operation of a ranking readjusting unit within the web searching system shown in FIG. 1.

### DETAILED DESCRIPTION OF THE PREFERRED EMBODIMENT

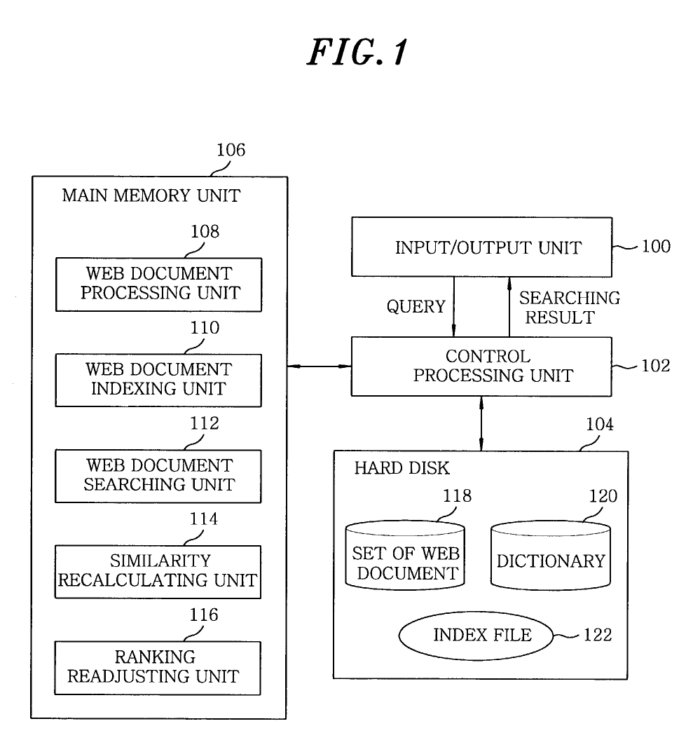

Referring to FIG. 1, there is described a homepage searching system based on a URL substring relationship in accordance with a preferred embodiment of the present invention.

The homepage searching system includes an input/output unit 100, a central processing unit (CPU) 102, a hard disk 104 and a main memory unit 106.

The central processing unit (CPU) 102 supervises a homepage searching process based on the URL substring relationship and controls operations of each block within the searching system. The main memory unit 106 includes software modules serving as process modules of the searching system based on the URL substring relationship. Such software modules include a web document processing unit 108, a web document indexing unit 110, a web document searching unit 112, a similarity recalculating unit 114 and a ranking readjusting unit 116. The input/output unit 100 receives a query from a user and loads the received query to the CPU 102, and, later, informs the user of the searching result. When a homepage searching request is provided from the input/output unit 100, the CPU 102 loads to the main memory unit 106 one of the above-mentioned software modules following the progress of an operation program, so that a homepage searching process in accordance with a preferred embodiment of the present invention is performed. A hard disk 104 stores therein a set of web documents 118 to be searched, dictionaries 120 for indexing and searching processes, and an index file 122 containing an index result.

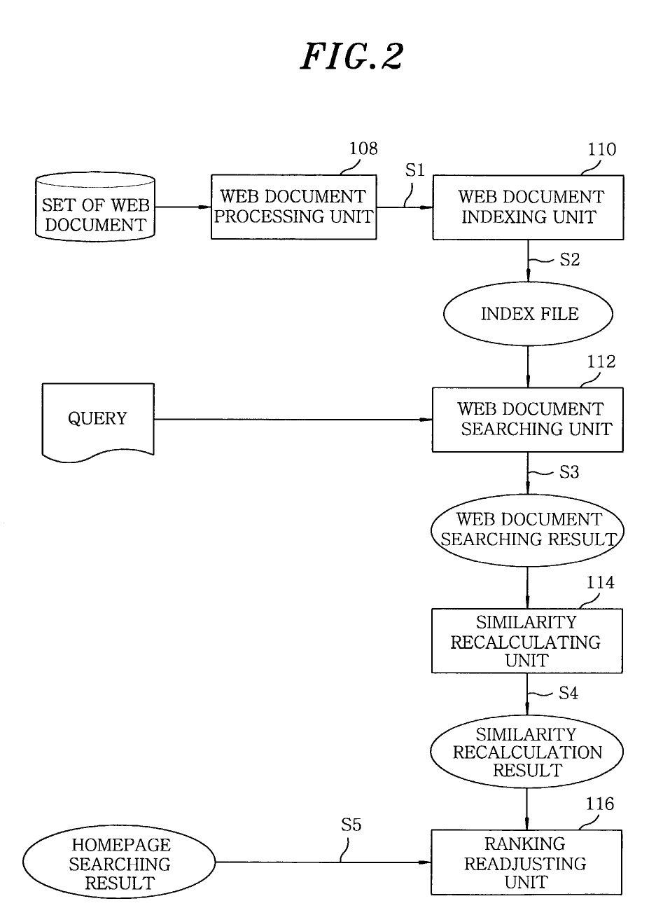

Referring to FIG. 2, there is described a web searching schema of the searching system shown in FIG. 1 in accordance with the preferred embodiment of the present invention. The operations of the web searching system of the present invention will now be described in further detail with reference to FIGS. 1 and 2.

Unlike in the conventional text information searching process, the web document processing unit 108 processes a web document in such a manner as to extract a general text therefrom in order to search a targeted homepage. That is, the web document processing unit 108 removes from the set of web documents 118 special characters, unnecessary tag sections, tags, etc., thereby obtaining the general text (Step 1).

Then, the web document indexing unit 110 indexes the extracted general text to generate an index file for use in performing the web searching process (Step 2). Thereafter, the web document searching unit 112 conducts a similarity calculation by considering the weights of the web documents and the searching query by way of employing the conventional searching method, decides rankings of the web documents and, then, outputs thus obtained searching result (Step 3).

The similarity recalculating unit 114 recalculates the similarity by applying URL substring relationships to the searching result which is provided from the web document searching unit 112 and, then, outputs the similarity recalculation result (Step 4). Afterwards, the ranking adjusting unit 116 readjusts the rankings of the web documents based on the recalculated similarity provided from the similarity recalculating unit 114 and, then, outputs the homepage searching result (Step 5).

To be specific, in the homepage searching system based on the URL substring relationship, the searching result is first extracted and expressed on a web document basis by the web document searching unit 112. At this time, the searching result is displayed according to the rankings of the web documents based on the similarities between index words of the web documents and the searching query. Thereafter, the searching result is recalculated by the similarity recalculating unit 114 on the basis of the URL substring relationships. In case a searched web document is a homepage, the document is likely to contain a larger number of subordinate documents than a web document which is not a homepage. Accordingly, the similarity of the homepage is recalculated to be increased as the number of its subordinate documents is increased.

The similarity-recalculated searching result is then subjected to the ranking readjusting unit 116 where the rankings of the web documents are readjusted according to the recalculated similarities. The document with a higher similarity is given a higher ranking. Thus, a homepage is supposed to be displayed at the top of the readjusted ranking list. Through this similarity recalculating process, a desired homepage can be found and provided as the searching result.

Operations of each unit of the web searching system will be described hereinafter in detail.

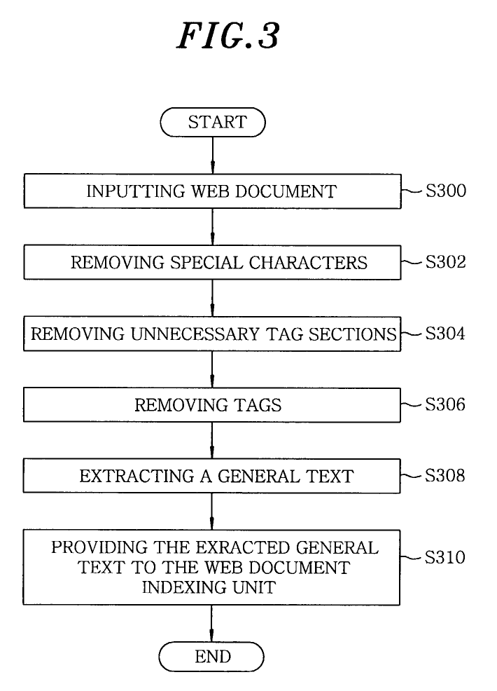

FIG. 3 is a flow chart for describing an operation of the web searching unit 108 shown in FIG. 1 in accordance with the preferred embodiment of the present invention.

If a web document is inputted (Step 300), the web document processing unit 108 removes special characters contained in the web document (Step 302) because the special characters need not be indexed. After removing the special characters, the web document processing unit 108 removes both unnecessary tag sections (Step 304) and tags (Step 306) The inputted web document created by using HTML uses a plurality of HTML tags in order to designate an expression type of various objects, e.g., a text and a picture. Most of these HTML tags just direct a document expression type such as a text line, a size, a location, and a color of an object. Therefore, these HTML tags are not subject to the indexing process and should be removed.

Then, the web document processing unit 108 extracts a general text from the web document from which the special characters, the tag sections and the tags are removed (Step 308). The extracted general text is required to be indexed within the web document. Thus, the extracted general text is provided to the web document indexing unit 110 (Step 310).

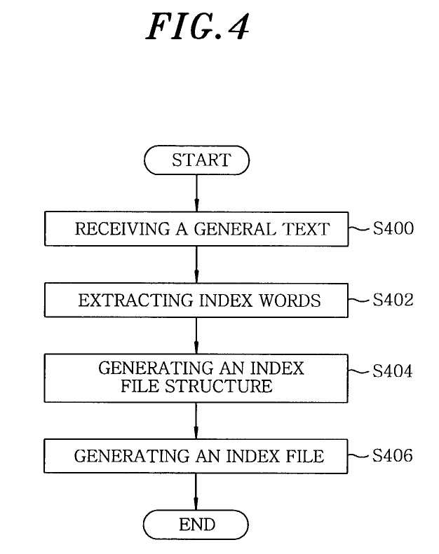

Referring to FIG. 4, there is provided a flowchart for illustrating an operation of the web document indexing unit 110 shown in FIG. 1 in accordance with the preferred embodiment of the present invention.

The web document indexing unit 110 receives from the web document processing unit 108 the extracted general text (Step 400). Then, the web document indexing unit 110 extracts index words from the received general text and calculates frequency information of the index words (Step 402). To be specific, calculated in the step 402 is the frequency information of the index words such as a frequency of the index words in the web documents and a frequency of the documents in which the index words appear (hereinafter referred to as an index word document frequency). Subsequently, the web document indexing unit 110 generates an index structure for the sake of an effective management of the extracted index words and the web document information (Step 404). Then, an index file structure is generated for the index structure (Step 406).

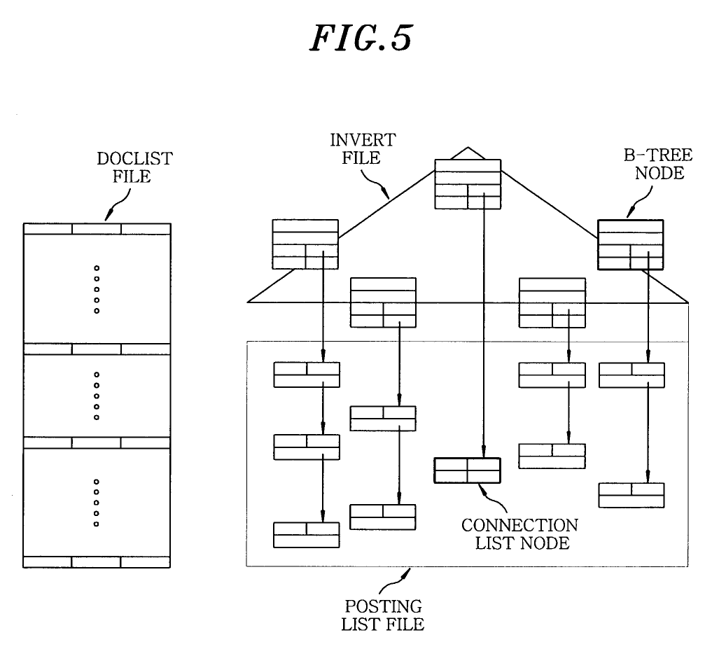

Referring to FIG. 5, there is illustrated an exemplary diagram of the index file structure. A Doclist file is used to store the information of the indexed web documents. Such information includes a document number, a URL, etc. An Invert file is utilized to store the extracted index words and is designed to have a structure for allowing a fast searching performance of the web document searching unit 112. Specifically, the index words and the number of the index words document frequency are stored in the Invert file. A Posting file stores therein information upon a frequency of the index words appearing in the web documents, a document number where an index word appears, etc. The information recorded in the Posting file is utilized at a time when the web document searching unit 112 searches for documents which contain a searching query. At this time, an index file generated to have the above-cited index structure is applied to the web document searching unit 112 (Step 406).

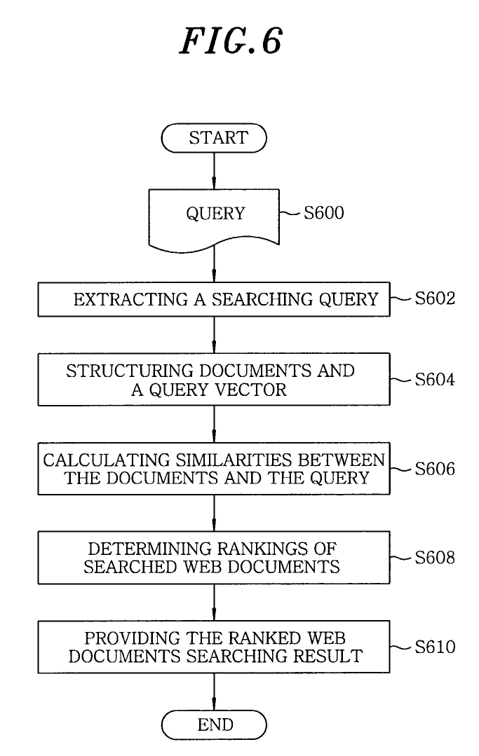

FIG. 6 sets forth a flow chart describing an operation of the web document searching unit 112 in FIG. 1 in accordance with the present invention.

The web document searching unit 112 receives a query and the index file generated by the web document indexing unit 112 (Step 600). Then, the web document searching unit 112 extracts a searching query from the received query (Step 602). Thereafter, the web document searching unit 112 structures vectors of documents and a query vector by using the extracted searching query (Step 604).

Subsequently, the web document searching unit 112 calculates similarities between the documents and the query by using the vectors of documents and the query vector (Step 606). Thereafter, the web document searching unit 112 determines the rankings of the searched web documents based on the calculated similarities between the documents and the query (Step 608). Then, the ranked web documents searching result is provided to the similarity recalculating unit 114 (Step 610).

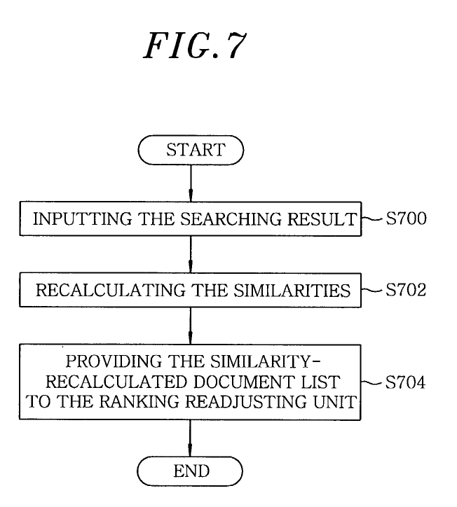

Referring to FIG. 7, there is provided a flowchart describing an operation of the similarity recalculating unit 114 shown in FIG. 1.

The similarity recalculating unit 114 receives the searching result, i.e., a document list, provided from the web document searching unit 112 (Step 700). Then, the similarity recalculating unit 114 recalculates the similarities based on URL substring relationships of the web documents (Step 702).

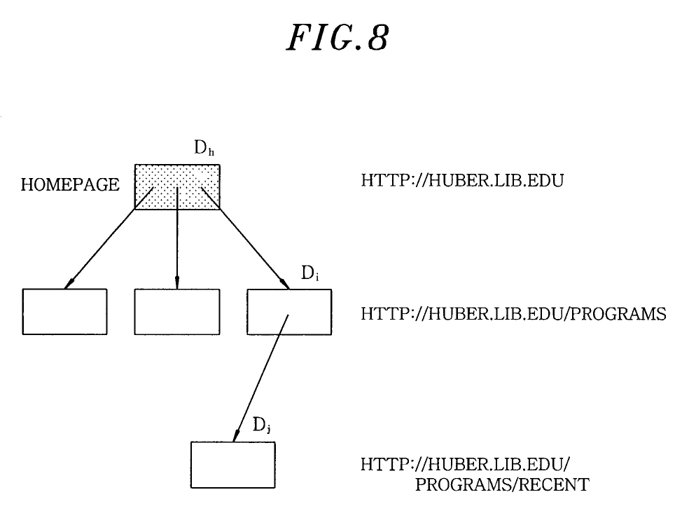

FIG. 8 shows an example of the URL substring relationship. To be specific, a URL of a homepage Dₕ, i.e., “http://huber.lib.edu” is contained in URLs of subordinate web documents Dₗ and Dⱼ. The similarity recalculating unit 114 recalculates the similarity based on such URL substring relationships.

For example, a searching result of a query sentence “Huber Library” and similarities of searched web documents are presented as follows.

TABLE 1

| | |
|---|---|
| Dⱼ (http://huber.lib.edu/programs/recent): | 17.5 |
| Dᵢ (http://huber.lib.edu/programs): | 14.3 |
| Dₕ (http://huber.lib.edu): | 11.8 |

In case of searching a general web document, a document list having the above order in the Table 1 is outputted as the searching result. However, in case of searching a homepage, the similarity of the homepage Dₕ should be estimated to be higher than any other web document, and a document list in which the homepage Dₕ is located on top thereof is required to be outputted. Accordingly, the similarity recalculating unit 114 recalculates the similarities of the web documents as follows: whenever a URL of a web document d appears in a URL of another web document b of the searching result list generated by the web document searching unit 112, the similarity of the web document d is increased by a predetermined constant (Step 702).

The equation for the similarity recalculation is as follows:

Sim(d)=Sim(d)+α Eq. (1)

wherein Sim(d) refers to a similarity between the searching query and the web document d; d represents a web document whose URL is contained in a URL of another web document; and a stands for a constant corresponding to an increase of the similarity. In this case, a can be defined in various ways. For example, α can be set to have a fixed value, e.g., 10 or 20 or can be set to be a similarity value of the web document listed on top of the searching result. In case of the latter, the value of α may be varied depending on the searching result. In this preferred embodiment, the value of α is fixed as “4” and the related similarity values obtained by the similarity recalculation is shown in Table 2.

TABLE 2

| | |
|---|---|
| Dⱼ (http://huber.lib.edu/programs/recent): | 17.5 |
| Dₗ (http://huber.lib.edu/programs): | 18.3 |
| Dₕ (http://huber.lib.edu): | 19.8 |

The similarity value of Dₕ is found to be increased more than any other subordinate web document as shown in the Table 2. The ranking readjusting unit 116 changes the rankings of the documents based on the recalculated similarities, so that a document list shown in Table 3 is obtained.

TABLE 3

| | |
|---|---|
| Dₕ (http://huber.lib.edu): | 19.8 |
| Dᵢ (http://huber.lib.edu/programs): | 18.3 |
| Dⱼ (http://huber.lib.edu/programs/recent: | 17.5 |

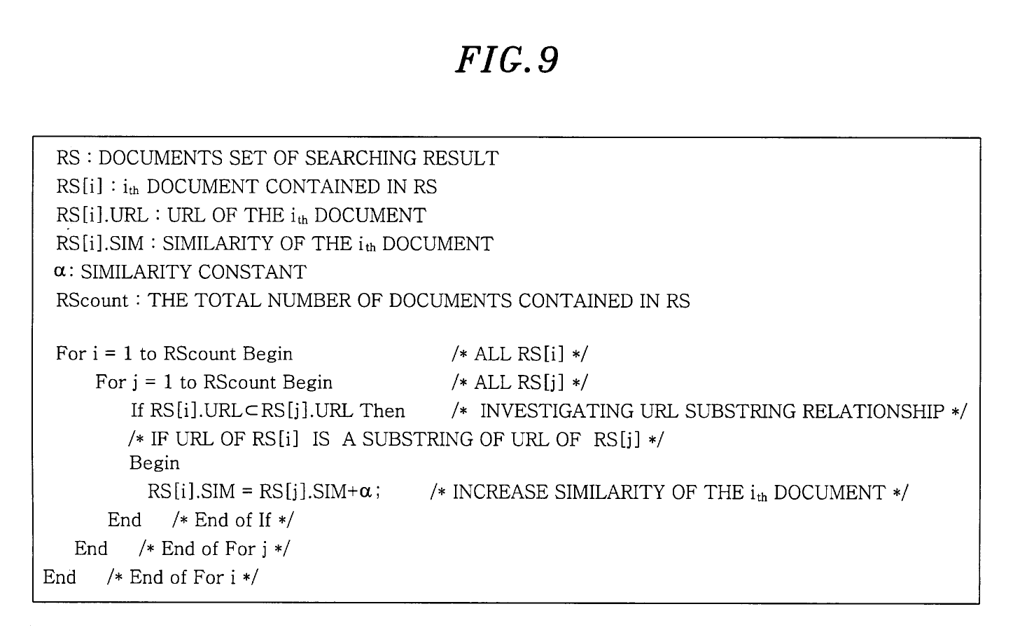

It can be seen from the Table 3 that the homepage Dₕ is promoted to be located at a highest position on the searching result list. FIG. 9 shows an example of a program source code that allows the homepage web document to be recalculated to have a higher similarity value by using the URL substring relationship as described above. The similarity-recalculated document list is transferred to the ranking readjusting unit 116 (Step 704).

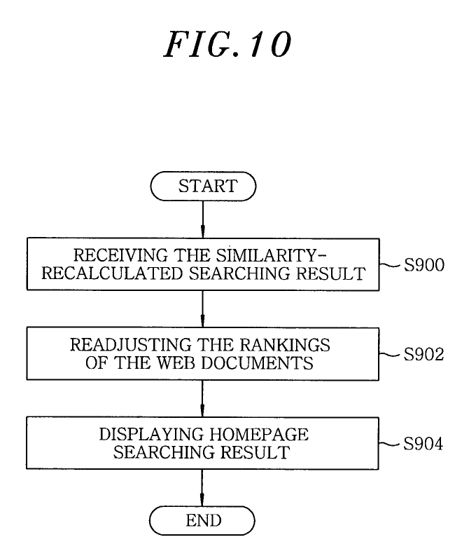

Referring to FIG. 10, there is described an operation of the ranking readjusting unit 116 in accordance with the preferred embodiment of the present invention.

The ranking readjusting unit 116 receives the similarity-recalculated searching result from the similarity recalculating unit 114 (Step 900). Then, the ranking readjusting unit 116 readjusts the rankings of the web documents on the searching result list by using the recalculated similarities (Step 902). Thereafter, the ranking readjusting unit 116 allows the web document corresponding to the homepage to be primarily displayed as the searching result (Step 904).

As described above, the present invention improves a conventional information searching method and allows a page serving as an entry point of a homepage to be searched prior to other documents. Accordingly, a user can determine whether a searched web document is a homepage or not without visiting all the URLs of the searched web documents. Further, since site information, i.e., a homepage of the web documents containing a searching query inputted from the user is primarily searched, the user can obtain a desired data more conveniently.

While the invention has been shown and described with respect to the preferred embodiment, it will be understood by those skilled in the art that various changes and modifications may be made without departing from the spirit and scope of the invention defined in the following claims:

What is claimed is:

1. A homepage searching method using a similarity recalculation based on a URL substring relationship, the method comprising the steps of:
(a) extracting a general text from web documents searched in response to a web searching request provided from a user;
(b) indexing the extracted general text to generate an index file for use in performing a web searching process;
(c) outputting a searching result defining rankings of the web documents by considering weights of the web documents and a searching query;
(d) recalculating similarities of the web documents on the ranking list by using URL substring relationships between the web documents; and
(e) readjusting the rankings of the web documents based on the recalculated similarities and, then, displaying the searching result in a manner that the web document corresponding to the homepage has a priority.

2. The method of claim 1, wherein the step (d) includes the stages of:
(d1) examining the substring relationships between URLs of the web documents; and
(d2) increasing the similarity of the web document whose URL is a substring of a URL of another web document.

3. The method of claim 1, wherein the similarity recalculation is performed in a manner that whenever a URL of a certain web document d appears in a URL of another web document, the similarity of the certain web document d is increased by a predetermined constant by using an equation as follows:
Sim(d)=Sim(d)+α
wherein Sim(d) refers to the similarity between the web document d and the searching query and α represents predetermined constant.
